(19) United States
(12) Patent Application Publication
(10) Pub. No.: US 2007/0169601 A1
(43) Pub. Date: Jul. 26, 2007

(54) Window shade cutting apparatus

(76) Inventors: Fu-Lai Yu, Taipei Hsieh (TW); Chin-Tien Huang, Taipei Hsieh (TW)

Correspondence Address: OLSON & HIERL, LTD., 20 NORTH WACKER DRIVE, 36TH FLOOR, CHICAGO, IL, 60606, US

(21) Appl. No.: 11/385,387

(22) Filed: Mar. 21, 2006

Related U.S. Application Data
(63) Continuation-in-part of application No. 11/338,465, filed on Jan. 24, 2006, now abandoned.

(51) Int. Cl. B26D 7/02; B26D 5/08

(52) U.S. Cl. 83/452; 83/454; 83/694; 83/613

(57) ABSTRACT

A cutting machine for window shades comprising a head rail, a bottom rail, and a plurality of light blocking sections. The cutting machine comprises a body with a platform for supporting the window shade, a clamp mechanism for securing the window shade, a blade rotationally connected to the body for cutting the window shade, and an actuating mechanism. The actuating mechanism is operatively connected to the blade, causing the blade to move in a rotational movement for cutting the secured window shade.

### RELATED APPLICATIONS

This application is a continuation-in-part of U.S. patent application Ser. No. 11/338,465 filed on Jan. 24, 2005.

### FIELD OF INVENTION

This invention relates to a cutting apparatus for a window shade and a method for using the apparatus. In particular, this invention relates to a cutting apparatus that can cut the ends of the components of a typical window shade, namely, the head rail, bottom rail and light blocking sections with a blade that travels an arcuate path in one action.

### BACKGROUND OF INVENTION

Window shades are a well known covering for windows and typically include a head rail, a bottom rail and a plurality of light blocking sections. The head rail and bottom rail are typically made of a relatively strong and rigid material. Each window shade component is designed to extend horizontally across the window space.

Window frames are built in a myriad of different widths. In order to accommodate this variation in widths, window shades of different widths must be available. One approach is to manufacture window shades on a special order basis, with each shade made to a specified width corresponding to a customer's needs. This approach is expensive as it lacks any economies of scale. Custom orders also require substantial time to tool up and manufacture each particular window shade.

In order to remedy this problem, various manufacturers have produced cutting machines that can trim standard size window shades to the desired width at the point of sale. Using these machines, a customer wanting to purchase a window shade simply needs to provide the measurement of his or her window frame and select a window shade larger than the window frame from a selection of standard sized window shades. The window shades can then be trimmed to the desired width at the point of sale using the cutting machine.

Existing examples of these cutting machines function by moving the blade in a linear motion along a straight path. Providing linear blade movement adds to the complexity required in the cutting machine as the action from an actuating mechanism must be translated from rotational movement to linear movement. This added complexity increases cost as well as reduces reliability of the machine.

What is needed is an apparatus that accurately and efficiently trims window shades in a simple machine, and that reduces the amount of force required to complete the cutting operation. The present invention meets these demands and overcomes the shortcomings of the prior art.

### SUMMARY OF THE INVENTION

The present invention is an apparatus for cutting window shades and a method for operating the apparatus. Typically, such window shades comprise a head rail, a bottom rail, and one or more light blocking sections. The present invention enables an operator to cut all these components in a single stage operation without undue actuating force required from the operator.

The cutting apparatus includes a body comprising a platform for supporting the window shade. The cutting apparatus further comprises a clamp mechanism mounted such that it is preferably positioned generally parallel to the platform, and such that it is adjustable to secure the window shade from movement relative to the cutting apparatus. A blade is disposed over the platform for cutting the secured window shade. The blade is rotatably connected to the body about a rotation axle laterally offset from the platform and is operatively connected to an actuating mechanism such as a lever. Since the blade is moved in a rotational manner to cut the window shade components, the complexity of the apparatus is reduced and less force by the operator is required than with a linear cut.

The present invention may also include an adjustable end guide. This end guide is located adjacent to the blade assembly and is configured to restrict how far the ends of the window shade components can extend through the blade cutting plane. In this way, a user of the present invention can accurately measure the amount of the window shade components to be trimmed and ensure that the desired amount is cut. In some embodiments, this end guide may be caused to move away from the ends of the window shade components during the cutting operation such that after the window shade components are cut, the cut pieces may be more easily removed from the machine.

The following briefly explains the process of cutting a window shade with the apparatus of the present invention. The machine operator determines the amount of the window shade to be trimmed and adjusts the end guide to correspond to that half that amount. The window shade, comprising the head rail, bottom rail, and light blocking sections are then placed on the platform so that one end of the window shade abuts the end guide. A clamp mechanism is then adjusted to compress the window covering in a stack and hold the window shade in place. Clamping in this manner prevents any lateral movement of the window shade and keeps the components of the window shade together, preferably under sufficient compression to minimize slippage and deformation of the components as the window shade is cut. The operator pulls a lever, causing the blade to rotate or travel along an arcuate path about its rotational axis. The rotational movement of the blade trims the window shade by cutting the head rail, bottom rail and light blocking sections in one action. The pulling of the lever may also cause pistons operatively connected to the actuating mechanism and the adjustable end guide to move and shuttle the end guide away from the trimmed window shade pieces to facilitate removal. The operator then returns the lever to the start position and resets the machine to trim the other end of the window shade as necessary.

Savings in apparatus complexity are achieved by using a rotationally movable blade. Additionally, since components are cut in one action and are held in place by the clamp mechanism, uneven cutting from slippage of the components during the cutting process is minimized.

Safety features are also optionally provided in the cutting apparatus to prevent against unintended actuation of the cutting apparatus or accidental exposure to cutting edges. These safety features are discussed in greater detail below.

### BRIEF DESCRIPTION OF THE DRAWINGS

In the drawings,

FIG. 1 is a perspective view of an embodiment of a window shade cutting apparatus in accordance with the present invention;

FIG. 2 is a perspective view of an embodiment of the window shade cutting apparatus in accordance with the present invention with a window shade;

FIG. 3 is an exploded view of an embodiment of a window shade cutting apparatus in accordance with the present invention;

FIG. 4 is a side view of the window shade cutting apparatus with the blade in the open position;

FIG. 5 is a side view of the window shade cutting apparatus with the blade in the closed position;

FIG. 6 is a rear perspective view of an alternate embodiment of a window shade cutting apparatus according to the present invention;

FIG. 7 is a front perspective view of the window shade cutting apparatus of FIG. 6 with a window shade;

FIG. 8 is a side elevated view of the window shade cutting apparatus of FIG. 6 in a first position;

FIG. 9 is a side elevated view of the window shade cutting apparatus of FIG. 6 in a second position;

FIG. 10 is a rear perspective view of another alternate embodiment of a window shade cutting apparatus according to the present invention;

FIG. 10A is an enlargement of a portion of the window shade cutting 5 apparatus of FIG. 10 with a restricting member in an engaged position;

FIG. 10B is an enlargement of a portion of the window shade cutting apparatus of FIG. 10 with a restricting member in a disengaged position;

FIG. 11 is another rear perspective view of FIG. 10;

FIG. 11A is an enlargement of a portion of the window shade cutting apparatus of FIG. 11 with a locking member in an engaged position;

FIG. 11B is an enlargement of a portion of the window shade cutting apparatus of FIG. 11 with the locking member in a disengaged position;

FIG. 12 is a front perspective view of another alternate embodiment of a window shade cutting apparatus according to the present invention;

FIG. 12A is an enlargement of a portion of the window shade cutting apparatus of FIG. 12;

FIG. 13 is an exploded perspective view of another alternate embodiment of the present invention with a safety lid;

FIG. 13A is a right side perspective view of the embodiment of FIG. 13 with the safety lid in operating position;

FIG. 14 is a left side perspective view of the cutter apparatus of FIG. 13;

FIG. 14A is a right side perspective view of the cutter apparatus of FIG. 13;

FIG. 15A is a left side perspective view of the cutter apparatus of FIG. 13 during a cutting operation; and

FIG. 15B is a left side perspective view of the cutter apparatus of FIG. 13 completing a cutting operation.

### DESCRIPTION OF PREFERRED EMBODIMENTS

The invention disclosed herein is susceptible to embodiment in many different forms. Shown in the drawings and described in detail hereinbelow is a preferred embodiment of the present invention. The present disclosure, however, is an exemplification of the principles and features of the invention, but does not limit the invention to the illustrated embodiments.

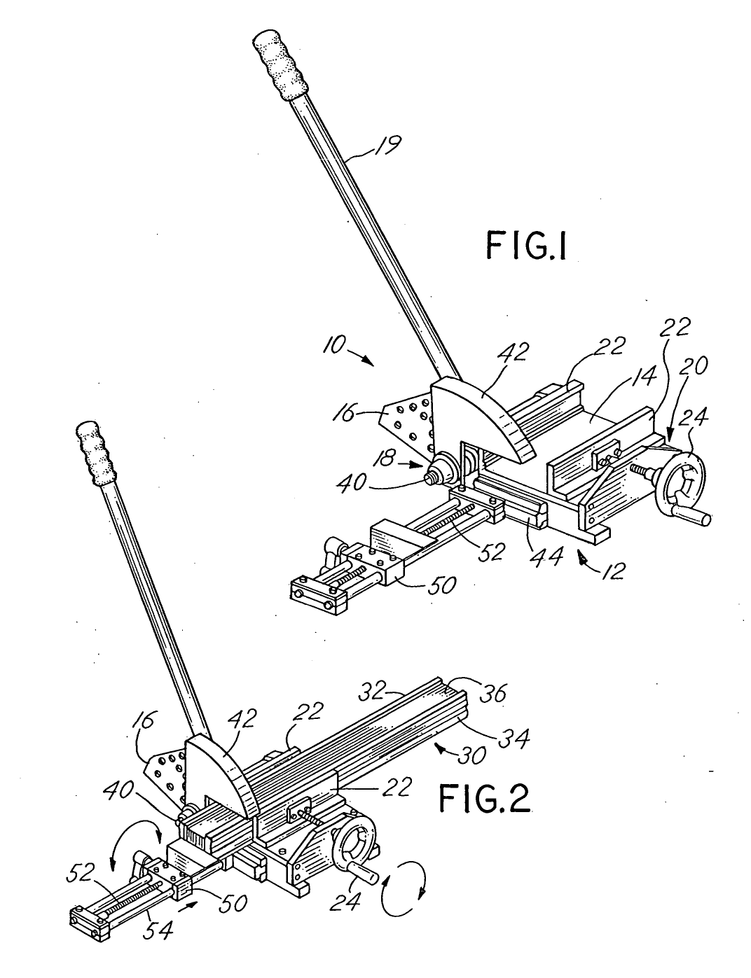

Referring to FIGS. 1 and 2, an embodiment of a window shade cutting apparatus 10 according to the present invention is shown. The apparatus 10 includes a body 12 comprising a platform 14 for supporting a window shade 30. Although shown as a planar member extending the width of the window shade 30, it should be understood that platform 14 can also take the form of vertical supports or other configurations suitable for supporting a window shade 30. The apparatus also includes blade 16 and an actuating mechanism 18 that is operated by lever arm 19. The apparatus 10 further comprises a clamp mechanism 20 including of clamping plates 22 that are adjustable by wheel 24. Clamp mechanism 20 is positioned relative to the body 12 such that clamping plates 22 can engage the window shade 30. Preferably, the clamp mechanism 20 is generally perpendicular to the platform 14 of the body 12. By turning wheel 24, clamping plates 22 are moved closer or farther apart relative to each other. Clamp mechanism 20 can thus be adjusted to secure window shade 30 tightly from movement, lateral or otherwise, on platform 14 during operation.

Preferably, one plate 22 is stationary while the second plate 22 is adjustably movable relative to the stationary plate, although both clamping plates 22 may be movable. By having the clamping plate 22 closest to the rotation axle 40 described herein, the head rail 32 is reliably positioned closer to the rotation axle 40 for easier cutting. Since head rail 32 is typically more rigid than bottom rail 34, orienting the window shade 30 so that head rail 32 is closest to the rotation axle 40 is preferred to take advantage of the stronger torque obtained at the cutting edge of blade 16 closer to the axle 40.

Window shade 30 includes head rail 32, bottom rail 34 and light blocking sections 36. In this example, window shade 30 is a cellular window shade with head rail 32 and bottom rail 34 made of polyvinyl chloride or a soft plastic material, and light blocking sections 36 are cellular sections. However, it should be understood that other window shades are compatible for use with this apparatus.

Preferably the window shade 30 is placed into the apparatus 10 horizontally so that the head rail 32 and bottom rail 34 abut clamping plates 22. Wheel 24 can then be used to slide clamping plates 22 to press against head rail 32 and bottom rail 34. Horizontal placement of window shade 30 is preferred since the blade 16 has a smaller distance to travel through the window shade 30, resulting in a smoother cut with less force. Additionally, light blocking sections 36 are typically more flexible than head rail 32 and bottom rail 34. In order to obtain optimal cutting, light blocking sections 36 should be compressed to prevent slippage and deflection as the window shade 30 is cut by blade 16. By orienting the window shade 30 horizontally, pressure from clamping plates 22 engaging the relatively more structurally rigid head rail 32 and bottom rail 34 to squeeze light blocking sections 36 for smoother and more even cutting. Nonetheless, vertical placement of window shade 30 into the clamping mechanism 20 may still be functionally acceptable.

Blade 16 is connected to body 12 by a rotation axle 40. The rotation axle 40 and blade 16 are disposed laterally offset from platform 14. While rotation axle 40 is shown in the FIGURES to be coplanar with platform 14, coplanarity is not required. It should also be recognized that the closer the rotation axle 40 is to platform 14, the stronger the torque obtained at the cutting edge of blade 16 when it comes in contact with window shade 30. In operation, blade 16 engages with or abuts against blade rest 44 after the blade 16 completes the cutting action. Blade rest 44 further supports the window shade 30 in conjunction with platform 14. Blade rest 44 is removable to facilitate replacement as necessary to ensure continued performance as it is worn by the cutting edge of blade 16. Blade 16 may also be removable.

Preferably, the operator of apparatus 10 is protected from the cutting edge of blade 16 by a blade guard 42. As shown in FIG. 2, the window shade 30 can be passed under blade guard 42. While the blade guard 42 shown is open on one side, it should be understood that blade guard 42 can constructed to encircle a periphery of window shade 30 while leaving an opening (not shown) to pass a window shade 30 through.

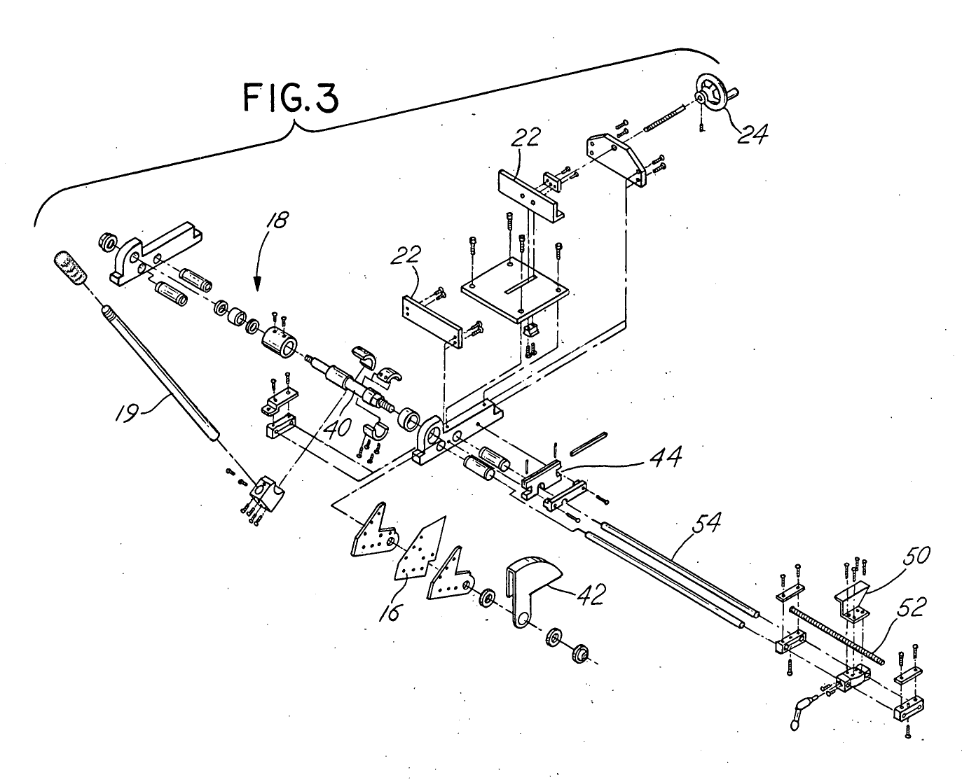

As shown in FIG. 3, apparatus 10 preferably further includes an adjustable end guide 50 that can be moved along a rail 52. End guide 50 is freely slidable or alternatively adjustable in predetermined increments along rail 52. End guide 50 is adjusted to abut window shade 30 to restrict how far the window shade 30 extends past the blade 16 and to measure the amount of shade 30 to be trimmed. End guide 50 is operatively connected to actuating mechanism 18 by end guide pistons 54 so that when actuating mechanism 18 is activated, end guide 50 moves out of contact with window shade 30 as blade 16 rotates about axle 40. This moves end guide 50 clear of the trimmed portion of window shade 30, facilitating removal of the trimmed portion from the apparatus 10.

Actuating mechanism 18 includes lever 19 and is operatively connected to blade 16. As previously discussed, end guide 50 is also be operatively connected to actuating mechanism 18. Actuating mechanism 18 shares a common rotation axle 40 with blade 16, as is shown in FIG. 3. Movement of lever 19 thus causes rotation of axle 40 and causes blade 16 to rotate in an arcuate path about the axis defined by axle 40.

In order to cut a window shade, the operator of the machine will first determine the total amount of the window shade 30 to be trimmed. The operator then adjusts the end guide 50 to correspond to one-half of the total amount to be trimmed. This is done since by trimming one half of the total amount from each end of the window shade 30, symmetry can be maintained on both ends of the window shade 30 with respect to the suspension or control cords on the window shade 30.

Window shade 30 is then placed on platform 14 and extended under blade guard 42 until one end of the window shade 30 abuts against end guide 50. Window shade 30 is preferably oriented horizontally so that head rail 32 and bottom rail 34 are facing clamping plates 22. Wheel 24 on clamp mechanism 20 is adjusted to bring clamping plates 22 in engagement with head rail 32 and bottom rail 34. By tightening clamping plates 22 against head rail 32 and bottom rail 34, light blocking sections 36 are compressed tightly to present a generally solid mass for cutting by blade 16. Tightening clamp mechanism 20 also holds window shade 30 securely in place to prevent lateral movement or displacement when blade 16 engages window shade 30.

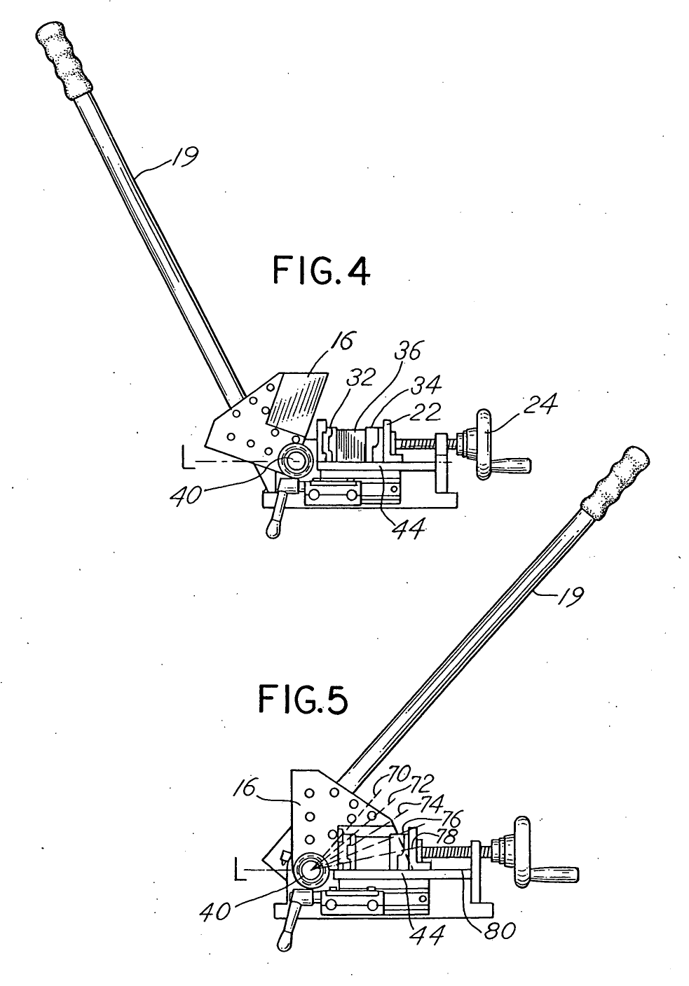

Once the window shade 30 is secured, the operator pulls lever 19, which is operatively connected to actuating mechanism 18. Actuating mechanism 18 causes blade 16 to move rotationally about the axis defined by rotation axle 40. As shown in FIGS. 4 and 5, the sequential positions of the cutting edge of blade 16 as it rotates is shown by dotted lines 70, 72, 74, 76 and 78 until the blade 16 reaches the final position 80 and engages the blade rest 44. The rotational movement of the blade 16 cuts the head rail 32, light blocking sections 36 and bottom rail 34 in one action. The pulling of lever 19 causes the end guide pistons 54, operatively connected to the actuating mechanism 18, to move and shuttle the end guide 50 away from the trimmed window shade sections for easier removal. The operator then returns the lever 19 to the start position and cuts the other side of the blind in the same manner.

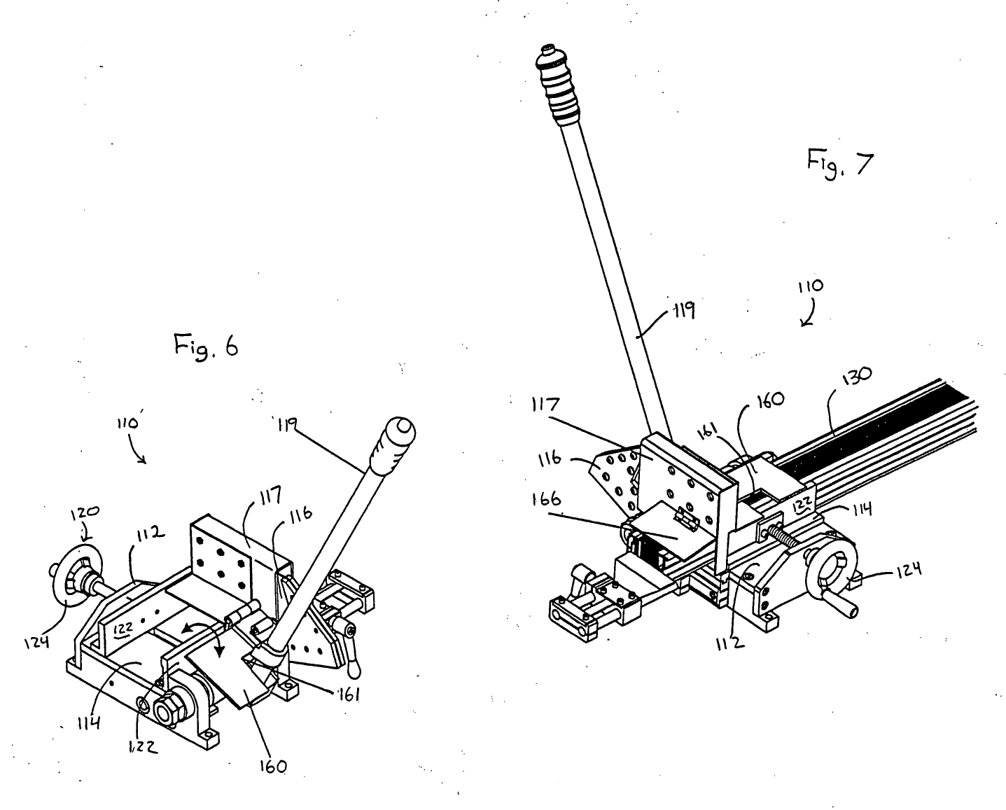

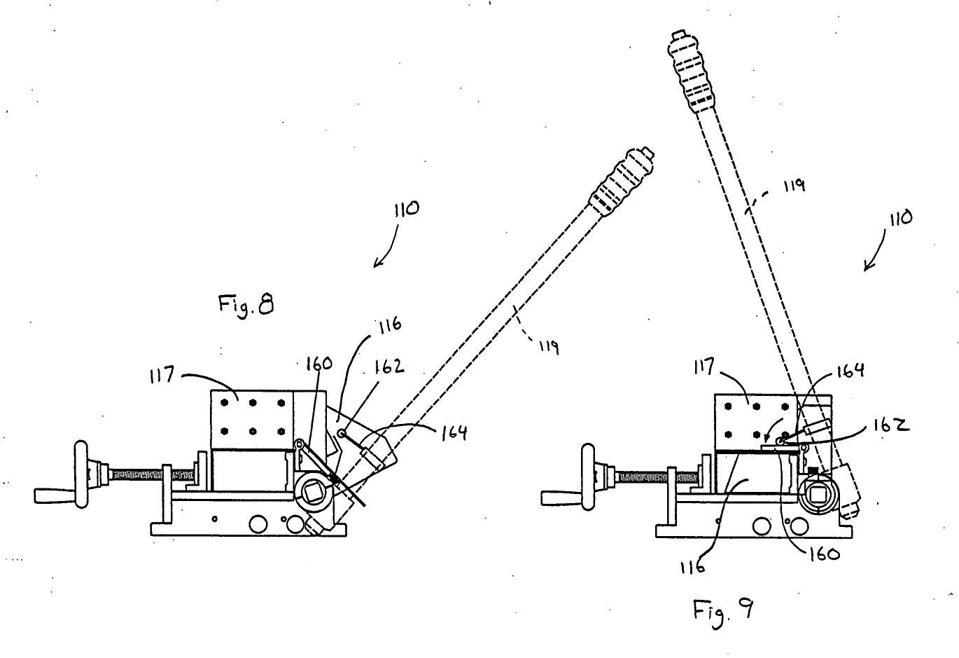

Referring to FIGS. 6 and 7, an alternate embodiment of the window shade cutting apparatus 110 according to the present invention is shown. The apparatus 110 includes a body 112 comprising a platform 114 for supporting a window shade 130. The apparatus also includes blade 116 and an actuating mechanism that is operated by lever arm 119. The apparatus 110 further comprises a clamp mechanism 120 including clamping plates 122 that are adjustable by wheel 124. Similar to the previous embodiment, turning wheel 124 causes clamping plates 122 to slide closer or farther apart relative to one another. A blade guard 117 is also provided and the blade 116 is moveable therethrough.

A movable guard member, such as guard plate 160 is also provided. Guard plate 160 is pivotally mounted to the body 112 of the cutting apparatus. The guard plate is moved between a first and a second position. In a first position, such as shown in FIG. 6, the plate rests adjacent to the lever arm 119. A cut out portion 161 of guard plate 160 provides a stop to obstruct inadvertent movement of the lever arm 119 when the guard plate 160 is in the first position, which prevents accidental cutting actuation of the apparatus 110.

Once the window shade 130 is placed into apparatus 110 on platform 114, the guard plate 160 is moved by an operator to the second position as shown in FIG. 7, and is laid over the window shade 130. As such inadvertent access by the operator to the blade 116 is restricted.

Referring to FIGS. 8 and 9, the lever arm 119 (shown in phantom) can then be moved to actuate the cutting blade 116 to cut the window shade 130 (FIG. 7). As the lever arm 119 is moved to cut the window shade, a capture member, such as magnet 162, which is operatively connected to the lever arm 119 by way of an arm member 164, is brought into contact with the guard plate 160. After cutting is completed, the operator returns the lever arm 119 back to its starting position, and the guard plate 160 is also pulled back to its first position by the movement of the lever arm 119. The guard plate 160 and magnet 162 constitute a simple and convenient safety measure to prevent injuries caused by accidental movement of the lever arm 119.

Referring again to FIG. 7, another feature of this preferred embodiment is described. A cover member, such as cover plate 166 is provided. Cover plate 166 is pivotally secured with the body adjacent to an opening in the blade guard 117 through which the window shade 130 is passed. The cover plate 166 pivots to open as the window shade 130 is passed through the blade guard 117 for cutting, and pivots to close when the window shade 130 is withdrawn. The cover plate 166 provides an additional safety measure against accidental injuries by preventing inadvertent contact with the blade 116.

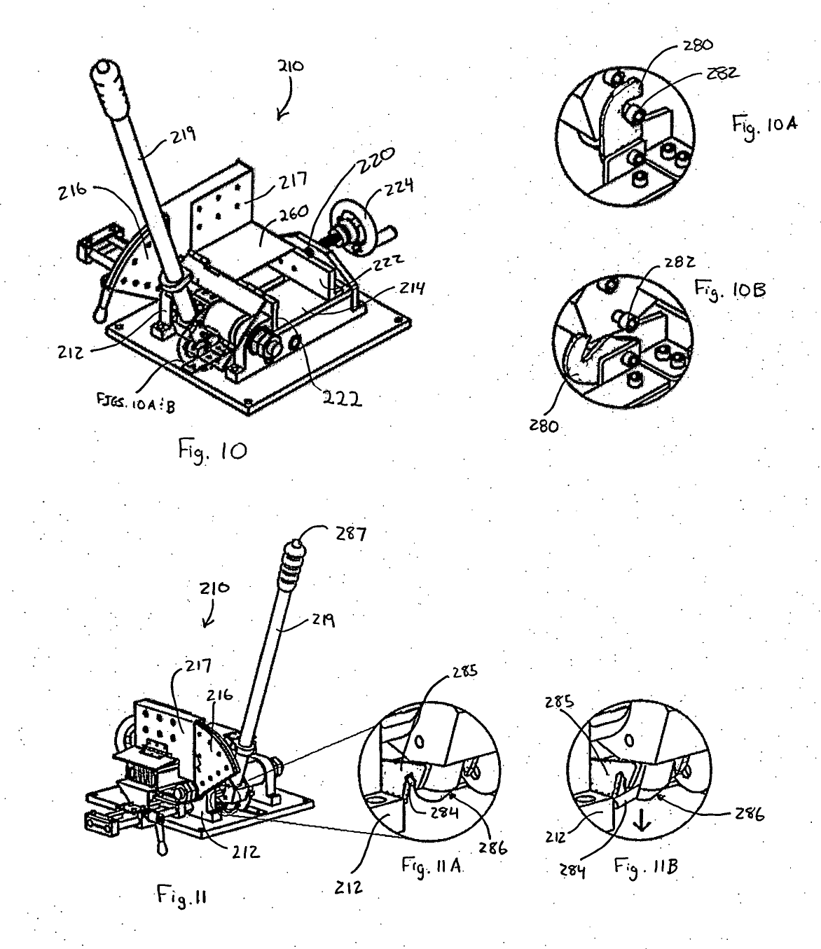

Referring to FIG. 10, another embodiment with a preferred safety feature is discussed. As in the previous embodiment, a cutting apparatus 210 includes a body 212 comprising a platform 214 for supporting a window shade. The apparatus also includes blade 216 and an actuating mechanism that is operated by lever arm 219. A clamp mechanism 220 having a pair of clamping plates 222 that are adjustable by turning wheel 224 is provided to hold the window shade in the correct position during the cutting operation. A blade guard 217 is also provided and the blade 216 is moveable therethrough. A movable guard member, which is pivotally mounted to the body 212 of the cutting apparatus, such as guard plate 260, is provided.

Shown in FIG. 10A is a restricting member, such as pivotal hook 280. When the lever arm 219 is in a starting position, a user may rotate the hook 280 so that it engages an impingement member, such as screw 282 fixed to the end of the lever arm 219. In order for the lever arm 219 to be actuated, the user must rotate the hook 280 such as shown in FIG. 10B to disengage from screw 282.

Yet another preferred safety mechanism is discussed with respect to FIGS. 11, 11A and 11B. Lever arm 219 is provided with a detent member, such as pin 284, secured with a bottom end 286 of the lever arm 219. A latch member 285 is secured to the body 212 of the cutting apparatus 210. When in a resting condition, pin 284 is engaged with latch member 285, thereby restricting movement of the lever arm 219. Pin 284 is operatively connected to push button 287 such that when button 287 is depressed, pin 284 is moved downwards so as to disengage from latch member 285, and permitting movement of the lever arm 219. Inadvertent movement of the lever arm 219 and cutting blade 216 are therefore prevented.

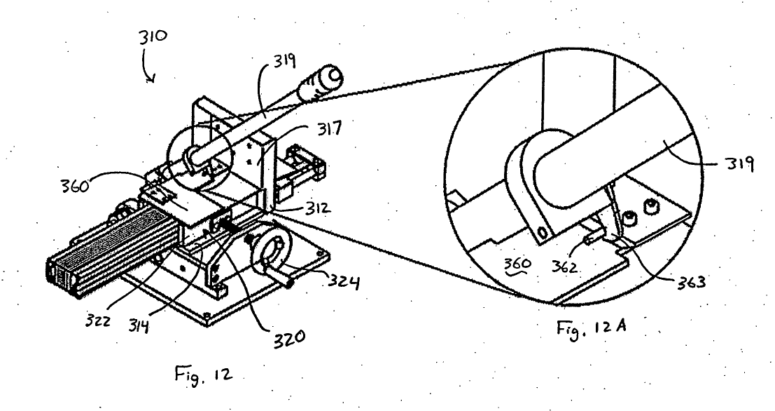

An alternative to the capture member shown in FIGS. 8 and 9, is discussed with regard to FIGS. 12 and 12A. In this embodiment, a cutting apparatus 310 is provided which includes a body 312 having a platform 314, a blade (not shown), an actuating mechanism that is operated by lever arm 319, a clamp mechanism 320 having a pair of clamping plates 322 that are adjustable by turning wheel 324, and a blade guard 317. Movable guard plate 360 is pivotally mounted to the body 312. Integral with the guard plate 360 is a pin 362, and secured with the lever arm 319 is a capture member, such as hook 363. Hook 363 is preferably spring biased and configured to permit the hook 363 to rotate and engage pin 363 as they come in contact with one another. The guard plate 360 may then be retracted in the manner described above.

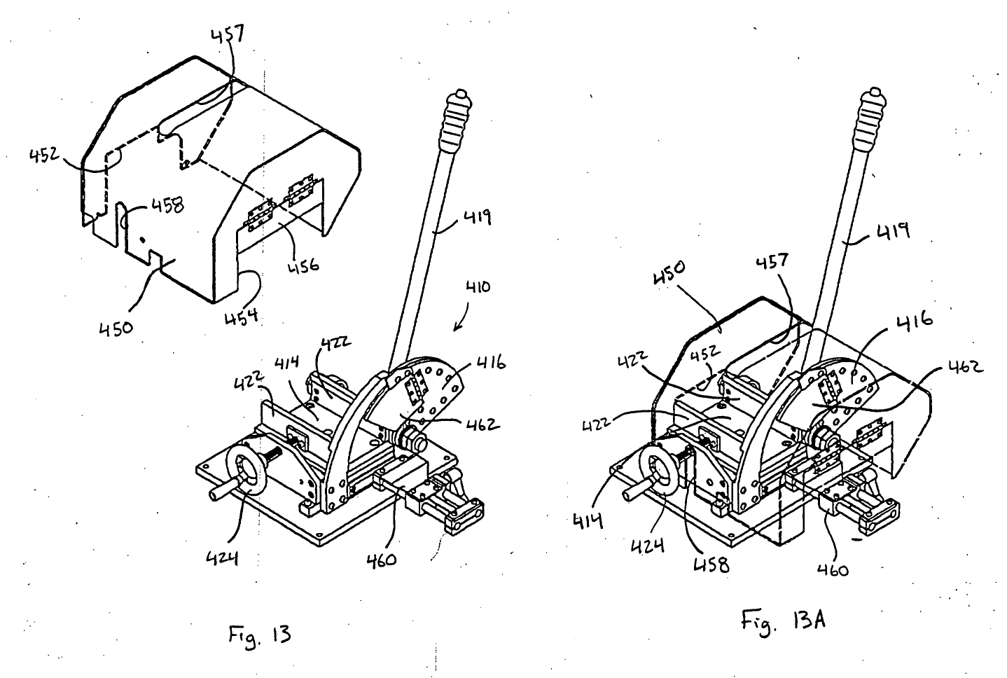

Referring to FIGS. 13 and 13A, yet another safety feature that may be utilized with the present invention is illustrated. Similar to the previous embodiment, a cutting apparatus 410 is provided which includes a body 412 having a platform 414, a blade 416, an actuating mechanism that is operated by lever arm 419, and a clamp mechanism 420 having a pair of clamping plates 422 that are adjustable by turning wheel 424. Cutting apparatus 410 further comprises two additional safety features.

The first is a safety lid 450 (which is shown partially in phantom) that can be placed over the cutting apparatus 410. The safety lid 450 is configured to substantially cover the entire cutting platform 414. A cut-out portion 452 is provided such that the operator may guide a window shade therethrough to be cut on the cutting apparatus 410. The end of the window shade to be cut is further passed through a second cut-out portion 454 until the window shade contacts the end guide 460. In this preferred embodiment, cut-out portion 454 is also provided with a guard plate 456 that is hinged with safety lid 450. Guard plate 456 restricts access by the operator to the blade 416 when in a lowered position. The safety lid preferably also includes a lever arm cut-out 457 and a wheel cut-out 458.

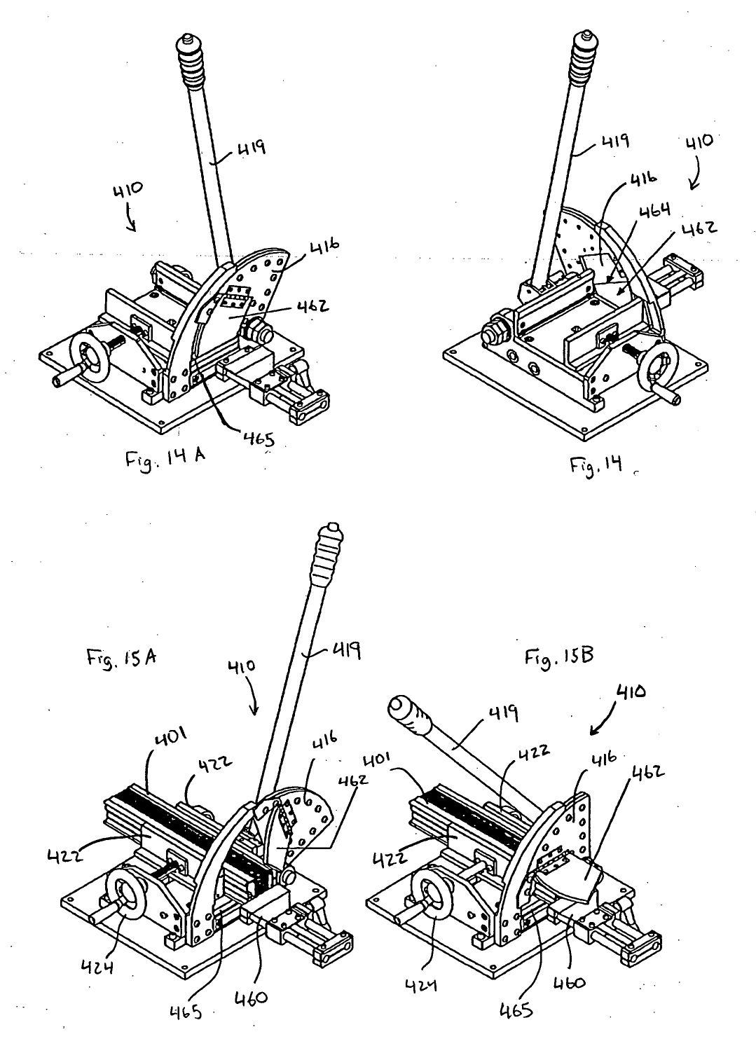

Another preferred safety feature found in this preferred embodiment is a cutter guard plate 462. The cutter guard plate 462 is pivotally mounted on the blade 416 or a mounting portion of the blade 416 such that as the blade 416 is moved, the guard plate 462 also moves. Referring to FIG. 14 (the safety lid is not shown for clarity), the edge 463 of the guard plate 462 extends beyond the blade edge 464 of blade 416. When no window shade is being cut, the cutter guard plate 462 will contact anvil 465, such as shown in FIG. 14A, in the event the lever arm 419 is actuated, thereby providing a further safeguard against accidents. Referring to FIGS. 15A and 15B, when a window shade 401 is in position to be cut, the window shade urges the cutter guard plate 464 out of alignment with the blade 416 such that the blade 416 is free to move and contact anvil 465. As the blade 416 is rotated by lever arm 419, the cutter guard 464 slides outward such that progression of the blade 416 is not impeded.

The foregoing description and the drawings are illustrative of the present invention and are not to be taken as limiting. Still other variants and rearrangements of parts within the spirit and scope of the present invention are possible and will be readily apparent to those skilled in the art.

What is claimed is:

1. An apparatus for cutting a window shade comprising a head rail, a bottom rail, and a plurality of light blocking sections, the apparatus comprising:
a body comprising a platform adapted to support the window shade;
a clamp mechanism positioned with the platform, the clamp mechanism being adjustable to compress and secure the window shade when the window shade is supported by the platform;
a blade disposed generally transverse to the platform, the blade further being connected to the body and movable along an arcuate path about a rotation axle;
an actuating mechanism operatively connected to the blade, operation of the actuating mechanism causing the blade to rotate about the rotation axle and to cut the secured window shade.

2. The apparatus of claim 1 further comprising an adjustable end guide configured to contact with the window shade.

3. The apparatus of claim 2 wherein the adjustable end guide is operatively connected to the actuating mechanism such that the actuation of the actuating mechanism causes the adjustable end guide to move out of contact with the window shade.

4. The apparatus of claim 1, further comprising a movable guard member secured to the body, the guard member adapted to move from a first position to a second position, such that in the second position access to the blade by an operator is restricted.

5. The apparatus of claim 4, further comprising a capture member operatively connected to the actuating mechanism and adapted to couple with the guard member such that the guard member is moved from the second position to the first position by movement of the actuating mechanism.

6. The apparatus of claim 4, wherein the guard member further comprises a cut-out portion adapted to limit movement of the actuating mechanism when the guard member is in the first position.

7. The apparatus of claim 1, further comprising a cover member secured to the body, and which is adapted to restrict access to the blade by an operator.

8. The apparatus of claim 1 wherein the clamp mechanism further comprises at least one clamping plate to secure the window shade by contacting and applying pressure to the head rail and bottom rail to compress the light blocking sections.

9. The apparatus of claim 8 wherein at least one clamping plate is stationary.

10. The apparatus of claim 1 wherein the actuating mechanism comprises a manually operable lever arm.

11. The apparatus of claim 1 wherein the actuating mechanism and the blade rotate about a common rotation axle.

12. The apparatus of claim 1 further comprising a safety lid adapted to enclose platform and the blade.

13. The apparatus of claim 12 wherein the safety lid comprises at least one cut out portion to provide access for actuating the actuating mechanism.

14. The apparatus of claim 1 further comprising a cutter guard member adapted to restrict movement of the blade when the apparatus is disengaged from a window shade.

15. A cutting machine for cutting a window shade comprising a head rail, a bottom rail, and a plurality of light blocking sections, the cutting machine comprising:
a body comprising a platform for supporting a window shade;
a clamp mechanism disposed with the platform, the clamp mechanism being adjustable to compress and secure the window shade;
a blade for cutting the window shade, the blade disposed generally perpendicular to the platform and laterally offset from the platform, the blade further being rotatably connected to the body; and
an actuating mechanism operatively connected to the blade, operation of the actuating mechanism causing the blade to rotate and cut the window shade.

16. The cutting machine of claim 15 wherein the cutting machine further comprises an adjustable end guide for contacting one end of the window shade.

17. The cutting machine of claim 16 wherein the adjustable end guide is operatively connected to the actuating mechanism and is moved out of contact with the window shade when the actuating mechanism is operated.

18. The apparatus of claim 15, further comprising a movable guard member secured to the body, the guard member adapted to move from a first position to a second position, such that in the second position access to the blade by an operator is restricted.

19. The apparatus of claim 18, further comprising a capture member operatively connected to the actuating mechanism and adapted to couple with the guard member such that the guard member is moved from the second position to the first position by movement of the actuating mechanism.

20. The cutting machine of claim 15 wherein the actuating mechanism comprises a manually operable lever arm.

21. The apparatus of claim 15, further comprising a cover member secured to the body, and which is adapted to restrict access to the blade by an operator.

22. The cutting machine of claim 15 further comprising a safety lid adapted to enclose platform and the blade.

23. The apparatus of claim 22 wherein the safety lid comprises at least one cut out portion to provide access for actuating the actuating mechanism.

24. The apparatus of claim 15 further comprising a cutter guard member adapted to restrict movement of the blade when the apparatus is disengaged from a window shade.

25. A method of cutting a window shade comprising a head rail, bottom rail, and light blocking sections, said method comprising the steps of:
positioning the window shade on a platform of the body;
securing and compressing the window shade from lateral movement by adjusting a clamp mechanism; and
cutting the window shade by causing an actuating mechanism to rotatably move a blade connected to the body wherein the blade rotates about an axis and cuts the window shade.

26. The method of claim 25 further comprising the step of adjusting an end guide to contact one end of the window shade.
